(19) United States
(12) Patent Application Publication
(10) Pub. No.: US 2011/0166698 A1
(43) Pub. Date: Jul. 7, 2011

(54) DELIVERY OF MEDICATION REGIMEN IN MEDICATION REMINDER DEVICE

(76) Inventor: Anthony Vallone, North Canton, OH (US)

(21) Appl. No.: 13/047,480

(22) Filed: Mar. 14, 2011

Related U.S. Application Data
(63) Continuation-in-part of application No. 11/712,357, filed on Feb. 28, 2007.

(51) Int. Cl. G06F 17/00; B65D 83/04

(52) U.S. Cl. 700/233; 221/1

(57) ABSTRACT

In healthcare scenarios, medication may be provided to an individual by a caregiver delivering a prescription to the individual or to a medication source (e.g., a pharmacist), the medication source providing the medication to the individual in a simple container, and the individual self-managing the medication. However, many opportunities for miscommunication, misunderstanding, or simple errors may arise in these human interactions, resulting in noncompliance with the medication regimen. Instead, the caregiver may provide the medication regimen to the medication source, who may (possibly with the assistance of automated processes) insert the medication into a medication reminder device that regulates the administration of medication doses according to the medication regimen, and send the medication reminder device to the individual. By reducing human involvement (particularly the self-management of the medication regimen by the individual), these processes may improve compliance with the medication regimen and reduce the incidence of medication errors.

### CROSS-REFERENCE TO RELATED APPLICATIONS

At least part of this patent application claims the benefit for priority, under 35 U.S.C. 120 and 37 C.F.R. §1.78, of U.S. application Ser. No. 11/712,357 titled “METHOD FOR FACILITATING COMPLIANCE WITH MEDICATION REGIMEN”, filed on Feb. 28, 2007, which is incorporated by reference as if fully rewritten herein.

### BACKGROUND

Within the field of medicine, many scenarios involve a formulation of a medication regimen for an individual by a caregiver, such as a physician, a nurse, or a nutritionist. For example, a caregiver may examine the individual, identify a health condition, and formulate a medication regimen comprising one or more medication instructions involving one or more medications. The caregiver may then provide a prescription to the individual, who may carry it to a medication source (e.g., a pharmacist) for filling. Alternatively, the caregiver may notify the medication source and provide an address of the individual, and the medication source may send the medication in a package (e.g., a bottle of pills or capsules, a package of tablets, a tube of ointment, or a vial of liquid) to the individual according to the medication regimen. Upon receiving the medication from the medication source, the individual may endeavor to comply with the medication regimen, e.g., by reviewing instructions provided by the caregiver and/or the medication source regarding the medication.

The medical community notes that medication errors are a major reason for patient hospitalization, with mortality estimates sometimes reported as accounting for over 90,000 deaths per year. Although there are numerous factors contributing to this crisis, baselines in health-related information creation, transfer, comprehension, and compliance are key elements of this problem.

In efforts to address this problem, the medical community is embracing the advancement of computer-based systems. Although these systems are moving into the forefront, they may not be fully efficient or effective and may exhibit the same problems inherent in a paper-based system, including increased user entry and retrieval time in searching for current and historical health-related information. Both systems exhibit common problems by relying on text-based communication, which may be ambiguous, region-specific, and either partly or fully miscomprehended by people interacting with the system. These problems may be exacerbated or compounded during the transfer of health-related information among healthcare professionals, due to the lack of standardization (resulting in “re-entry” errors) and comprehension issues, where content of material and interpretation of health-related information is variable, based on organizational and cognitive abilities.

The transfer of health-related information between the medical community and the general population also continues to have serious problems, since non-standardized and often incomplete health-related information may be imperfectly “pieced together” by multiple healthcare providers and the patient to create an incorrect or incomplete medical record. This problem may also arise when health-related information (including the vehicle, route, dosage, time of day, administration, and/or use of a medication) is not easily transferred, accessed, or understood by the general population.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The provision of medication to an individual through the exchange of prescriptions and/or the provision of medication to the individual for self-management may result in various forms of miscommunication and/or misunderstanding that reduce compliance with the medication regimen. As a first example, miscommunication may arise between the caregiver and the medication source that results in the provision of incorrect medications, incorrect medication doses, and/or incorrect instructions to the individual. As a second example, miscommunication may arise between the caregiver and/or the medication source and the individual, resulting in a misunderstanding of the medication regimen by the individual. As a third example, even if the correct medication, medication doses, and medication instructions, the individual may receive the medication from the medication source but may err in the self-management of the medication (e.g., taking the wrong medication, and/or taking medication at the wrong time, in an incorrect dosage, or in an incorrect manner). Such errors in the provision and/or self-administration of the medication may result in significant morbidity and mortality for the individual.

The present disclosure relates to the provision of medication prescribed by a caregiver, generated by a medication source, and delivered to the individual using a medication reminder device for communicating health-related information and for providing doses of medication in compliance with a medication regimen. Once a medication regimen has been formulated by the caregiver, the medication regimen many be communicated to a medication source, which may prepare the medication for provision to the individual. However, instead of sending the medication in a container such as a bottle, package, tube, or vial, the medication source may load the medication instructions and the medication doses of the prescribed medications into a medication reminder device. The medication reminder device may include a chronometer, by which it monitors time, and logic for determining when to generate medication reminder messages based on the chronometer and the medication instructions. For each medication instruction, and more specifically for each medication event corresponding to each medication instruction, the device generates a medication reminder message by displaying icons that are representative of the medication instruction. The medication reminder device also features a medication chamber that contains a dose of the medication, and the medication reminder message may reference the medication chamber. Upon storing the medication instructions in the medication reminder device, and upon inserting one or more medication doses of one or more medications into one or more medication chambers of the medication reminder device, the medication source may provide the medication reminder device to the individual. This coordinated provision of the medication among the caregiver, the medication source, and the individual may considerably improve the compliance of the individual with the medication regimen, and may considerably reduce morbidity and mortality resulting from errors in the provision and administration of the medication.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of two exemplary scenarios featuring a provision of medication prescribed by a caregiver and provided by a medication source to an individual.

FIG. 2 presents a component block diagram an exemplary medication reminder.

FIG. 3 presents an illustration of an exemplary medication reminder configured to present medication reminder messages using icons.

FIG. 4 presents an illustration of an exemplary medication reminder featuring one or more medication chambers respectively containing one or more medication doses of one or more medications specified by a medication instruction.

FIG. 5 is an illustration of two exemplary scenarios featuring a provision of medication prescribed by a caregiver and provided by a medication source to an individual in accordance with the techniques presented herein.

FIG. 6 is a flow chart illustrating an exemplary method of providing medication of a medication regimen to an individual.

FIG. 7 is an illustration of an exemplary computer-readable medium comprising processor-executable instructions configured to embody one or more of the provisions set forth herein.

FIG. 8 is an illustration of exemplary scenarios featuring an insertion of medication doses of medications into the chambers of a medication reminder device according to a medication instruction relationship.

FIG. 9 is an illustration of an exemplary scenario featuring a refilling by a medication source of medication stored in a medication reminder device.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The present disclosure relates to the field of healthcare, and particularly to the formulation of a medication regimen by a caregiver for an individual. As a first example, the caregiver may comprise a physician, nurse, or other healthcare practitioner who formulates a medication regimen comprising one or more medications in order to prevent, address, and/or ameliorate a health condition of the individual. As a second example, the caregiver may comprise a nutritionist or other vitamin specialist who formulates a vitamin regimen comprising one or more vitamins in order to improve the general health of the individual.

More particularly, the present disclosure relates to the manner in which the medication of the medication regimen is provided to the individual. In some scenarios, the individual may simply obtain and use suitable medication, such as “over-the-counter” prescriptions that may be directly available to the individual. However, in many other scenarios, the medication is provided to the individual through a medication source, such as a pharmacy, a hospital or clinic, or a manufacturer of the medication. In some such scenarios, the individual may obtain the medication by visiting the medication source with a verifiable set of medication instructions comprising the medication regimen, and the medication source may provide the medication to the individual from a medication stock. In other scenarios, the caregiver and/or individual may submit a request for the medication to a medication source (e.g., via telephone, fax, or internet), and the medication source may prepare a package containing the medication and send the package to the individual.

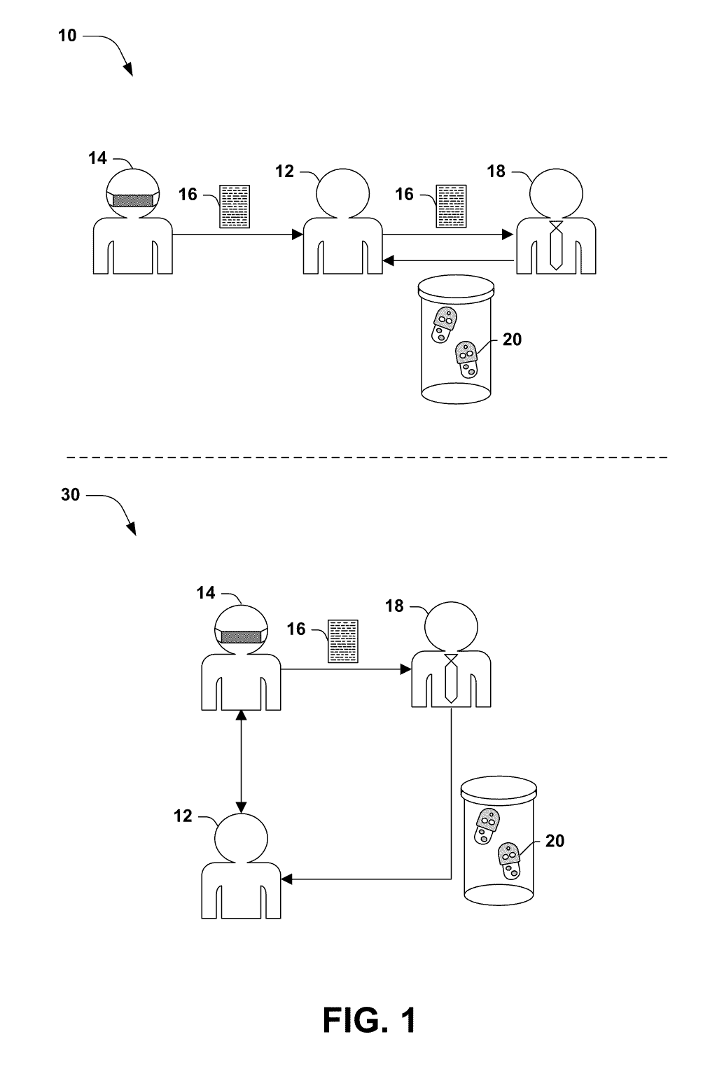

FIG. 1 presents an illustration of two exemplary scenarios featuring an exchange of information relating to a medication regimen formulated for an individual 12. In the first exemplary scenario 10, a caregiver 14 may formulate the medication regimen and provide it to the individual 12 in the form of a prescription 16 (e.g., a letter or certificate indicating an authorization to receive a regulated medication). The individual 12 may transfer the prescription 16 to a medication source 18, such as a pharmacist, who may fill the prescription 16 and provide the medication 20 to the individual 12. The medication source 18 may provide the medication 20 in a simple package, such as a bottle of pills or capsules, a package of tablets, a tube of ointment, or a vial of liquid. In a second exemplary scenario 30, rather than providing the prescription 16 to the individual 12, the caregiver 14 may deliver the prescription 16 directly to a medication source 18 (e.g., a pharmacist preferred by the individual 12), and the medication source 18 may send the medication 20 to the individual 12. In either exemplary scenario, the caregiver 14 and/or the medication source 18 may also provide written or oral instructions to the individual 12 regarding the self-administration of the medication 20 (e.g., the frequency and dosing of the medication 20; the route by which the medication 20 is to be self-administered, such as oral, topical, inhalation, or intramuscular or intravenous injection; potential side-effects of the medication 20; and compatibility warnings about other substances with which the medication 20 may harmfully interact). However, in both exemplary scenarios, the individual 12 is left with the medication 20 and instructions, and undertakes the responsibility of administering the medication 20 to him- or herself.

The exemplary scenarios presented in FIG. 1 illustrate some potential opportunities for miscommunication, misunderstand, or human errors in the provision and self-administration of the medication 20. As a first example, the caregiver 14 may err or miscommunicate in the contents of the prescription 16 provided to the individual 12 and/or the medication source 18. As a second example, the medication source 18 may misunderstand the prescription 16, or may err in the provision of the medication 20 to the individual 12, such as providing an incorrect medication 20 or an incorrect dosage of the medication 20. As a third example, the caregiver 14 and/or the medication source 18 may err or miscommunicate the instructions for the self-administration of the medication 20 to the individual 12, such as specifying an incorrect dosage or frequency, or neglecting to mention a side-effect or incompatibility with another medication 20. Additionally, the instructions provided by the caregiver 14 may conflict with the instructions provided by the medication source 18, thereby causing confusion. As a fourth example, the individual 12 may misunderstand the instructions provided by the caregiver 14 and/or the medication source 18, or may err in the self-administration of the medication 20 (e.g., taking the wrong medication 20 or an incorrect dosage of the medication 20, erring in the route of administration, or taking the medication 20 under incorrect circumstances). Such misunderstanding or errors may increase in frequency and/or severity if the cognitive function of the individual 12 is impaired, and/or as the complexity of the medication regimen of the individual 12 increases (e.g., the number, kind, and self-administration instructions of medications comprising the medication regimen of the individual 12). Due to any of these incidents of miscommunication misunderstanding, conflict, or error, the medication 20 is not self-administered by the individual 12 as intended by the caregiver 14, thereby reducing the preventative, curative, and/or palliative properties of the medication 20.

Compliance of an individual 12 with a medication regimen may be promoted by programming one or more medication instructions comprising the medication regimen into a medication reminder device that the individual 12 may carry and use to attend to the details of the medication regimen. For example, the medication reminder device may monitor the current date and time, and upon detecting a date and time specified by a medication instruction, may present the medication instruction to the individual. Moreover, the medication reminder device may present the medication instruction in various ways. For example, a set of icons may be devised that depict various aspects of a medication instruction (e.g., a color, size, and/or type of pill; a color and/or amount of a liquid; the date and/or time of the medication instruction; a manner of ingesting a type of medication; one or more conditions under which the medication is to be taken, such as with food; and/or a health condition that the medication is prescribed to address). The medication reminder device may therefore present a medication instruction to the individual by selecting a set of icons that together depict the medication instruction. The use of pictorial icons may reduce errors in the communication of the medication regimen among one or more caregivers and the individual, and the compliance of the individual with the medication regimen. The medication reminder device may also utilize icons to communicate with the caregiver 14 and/or the medication source 18, thereby enabling everyone involved in the care of the individual to use the same lexicon to communicate various aspects of the medication regimen.

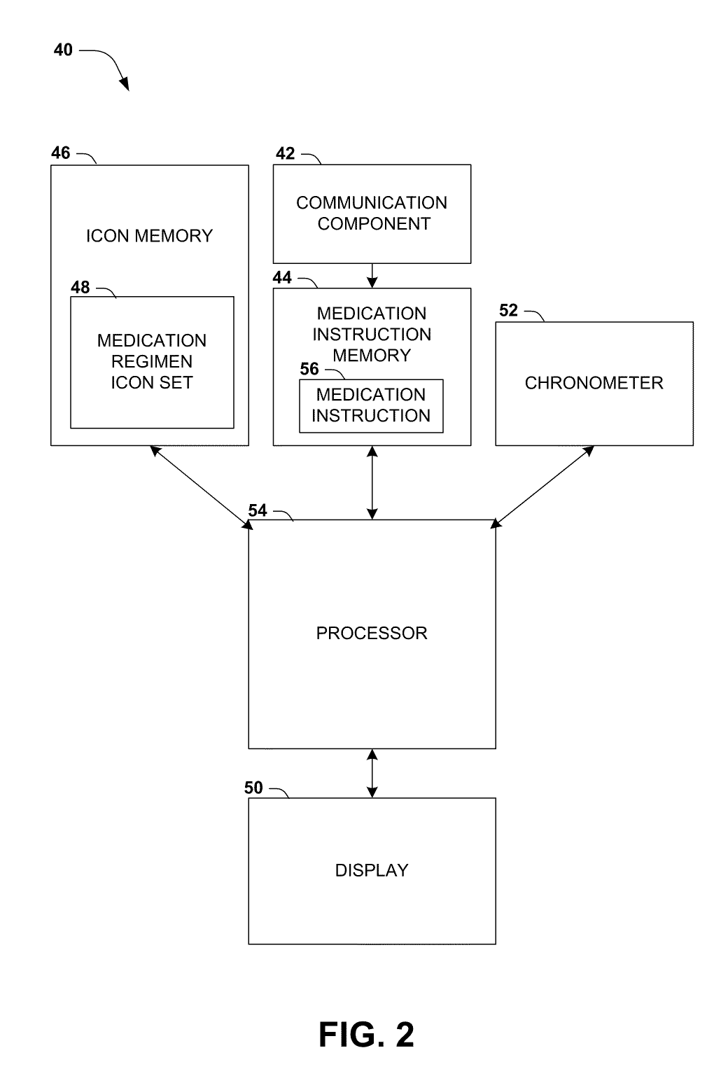

FIG. 2 presents an exemplary illustration of a medication reminder device configured device in accordance with the present disclosure. In this exemplary illustration, the medication reminder device 40 comprises a communication component 42 configured to receive medication instructions 56 comprising a medication regimen. The device also comprises a medication instruction memory 44, which is configured to store the medication instructions 56 received by the communication component 42, and an icon memory 46, which contains a medication regimen icon set 48. The device also comprises a display 50, such as an LCD, LED, projector, etc. The device also comprises a processor 54, which monitors the medication instructions 56 in the medication instruction memory 44 and generates a medication reminder message by displaying on the display 50 one or more icons selected from the medication regimen icon set 48 that together depict the medication instruction 56. The medication reminder device 40 also comprises a chronometer 52 and uses the information provided thereby to determine when to generate the reminder message(s) for each medication instruction 56. This information may either be precisely monitored and displayed, e.g., in accordance with an instruction to take a certain medication at 4:00 P.M., or may be more coarsely monitored to generate the medication reminder message in a broader time frame, e.g., in accordance with an instruction to take a certain medication in the evening.

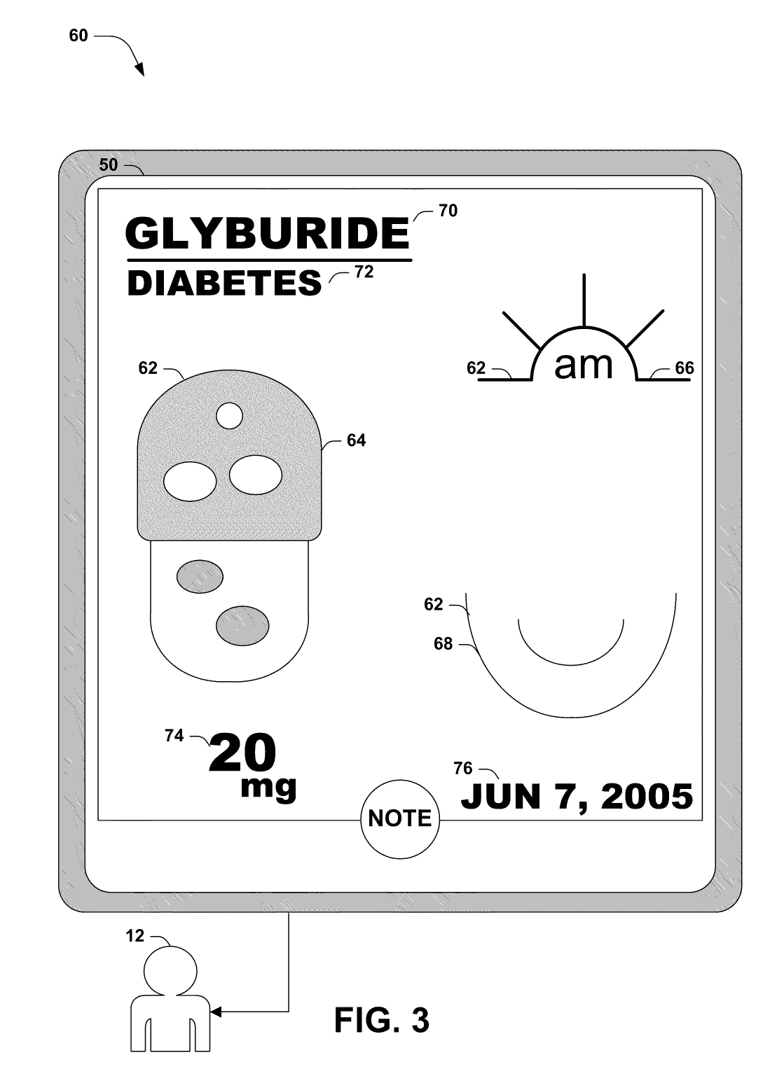

FIG. 3 illustrates a message that may be generated and presented by a medication reminder device 60 to indicate a medication instruction 56 to the individual 12 for whom the medication regimen has been prescribed. The medication reminder device 60 comprises a display 50 that displays to the individual 12 a medication reminder message through the presentation of a set of icons 62 that together depict the medication instruction 56. For example, the icons 62 may depict the medication 64 (e.g., a capsule), the time of day 66 in which the medication is to be taken (e.g., in the morning), and the method 68 by which the medication is to be taken (e.g., orally.) Information in the medication instruction 56 that is difficult to depict may be represented in text form, such as the name 70 of the medication 64, the condition that the medication 64 is prescribed to address 72, the dosage 74 of the medication 64, and the current date 76.

In addition to reminding an individual of a medication instruction 56, a medication reminder device 40 may also contain and/or administer medications 64 in compliance with a medication regimen. For example, the medication reminder device 40 may include a medication chamber that contains one or more doses of one or more medications 64, such as an enclosure containing one or more pills or a vial containing a liquid medication. In some embodiments, the medication reminder device 40 may include multiple medication chambers, each configured to store one or more medication doses of one or more medications 64, and an individual may be instructed to take all of the medication doses of medications in a particular medication chamber in compliance with a particular medication instruction 56. Moreover, a medication reminder device 40 may, while notifying an individual of a medication instruction 56, indicate to the individual which of the several medication chambers contains the medication 64 to be consumed.

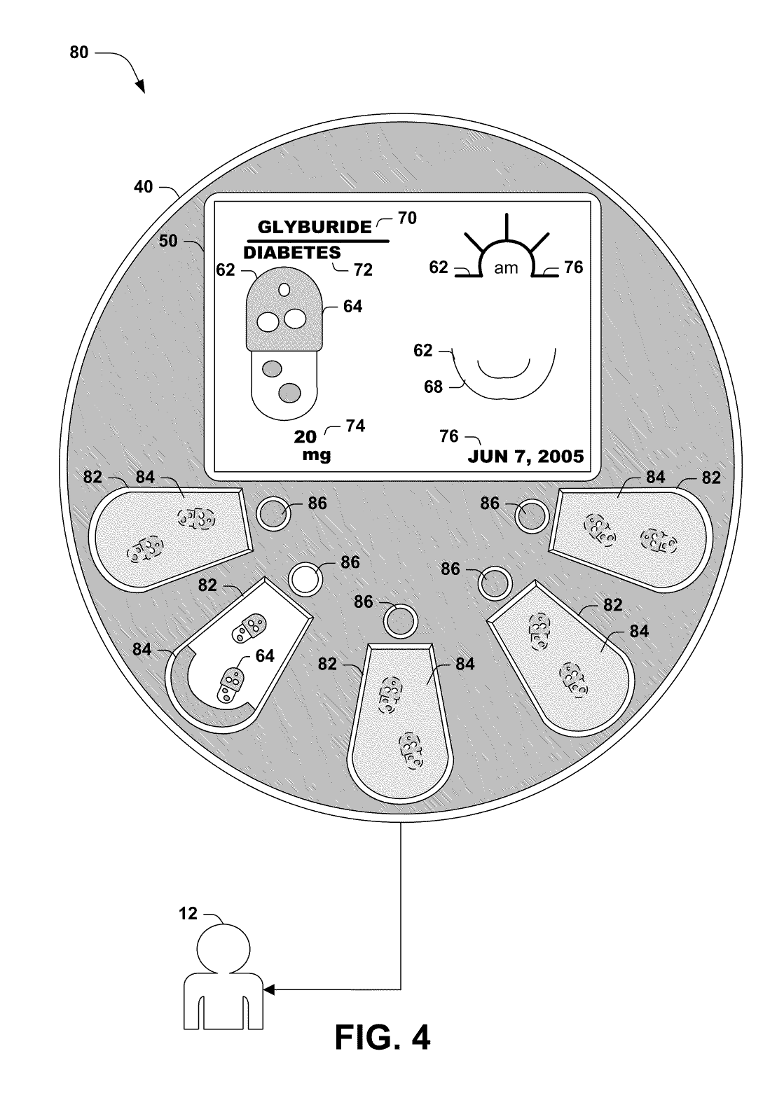

FIG. 4 presents an illustration of an exemplary medication reminder device 80 comprising a set of medication chambers 82, each configured to store one or more medication doses of one or more medications 64. The medication reminder device 80 is configured to store medication instructions 56 and to present on a display 50 a medication reminder message (e.g., by displaying a set of icons 62 that together depict the medication instruction 56). Additionally, the medication reminder device 80 comprises a set of medication chambers 82, each storing one or more medication doses of a medication 64 corresponding to a medication instruction 56. The medication reminder device 40 may comprise one medication chamber 82 storing one or more medication doses of a medication 64 (e.g., a bottle containing a large number pills), or two or more medication reminder chamber 82, each partitioned from the others and containing the medication doses of one or more medications 64 specified by a particular medication instruction 56. For example, respective partitioned medication reminder chambers 82 may include a cover 84 (such as a small door covering an aperture through a surface of the medication reminder device 80 and penetrating into the medication chamber 82), and the individual 12 may access the medication doses of the medication 64 by opening the cover 84 of a medication chamber 82. Moreover, the medication reminder device 80 may include a mechanism for identifying a particular medication chamber 82 containing the medication doses of the medication 64 specified by a presented medication instruction 56. For example, the exemplary medication reminder device 80 of FIG. 4 includes a visual indicator 86 (such as a small light source) for each medication chamber 82, and upon displaying a medication instruction 56 with respect to a particular medication chamber 82, the medication reminder device 80 may activate the visual indicator 86 (e.g., lighting the light source) to indicate the medication chamber 82 that the individual 12 is to access in order to comply with the medication regimen.

In this manner, the features of the exemplary medication reminder devices 40 presented in FIGS. 2, 3, and 4 promote the compliance of an individual 12 with a medication regimen. According to the techniques presented herein, it may be advantageous to incorporate a medication reminder device 40 in the process of formulating a medication regimen and dispensing medication 64 to an individual 12. In particular, rather than providing medication 64 in a simple package and conveying instructions regarding the self-management of the medication 64 to the individual 12 in oral or written form, the medication source 18 may provide the medication 64 to the individual 12 pre-loaded into a medication reminder device 40, and with the details of the medication regimen loaded into the medication reminder device 40. This manner of dispensing the medication 64 to the individual 12 may remove several opportunities for miscommunication, misunderstanding, and human error, and may significantly improve the compliance of the individual 12 with the medication regimen.

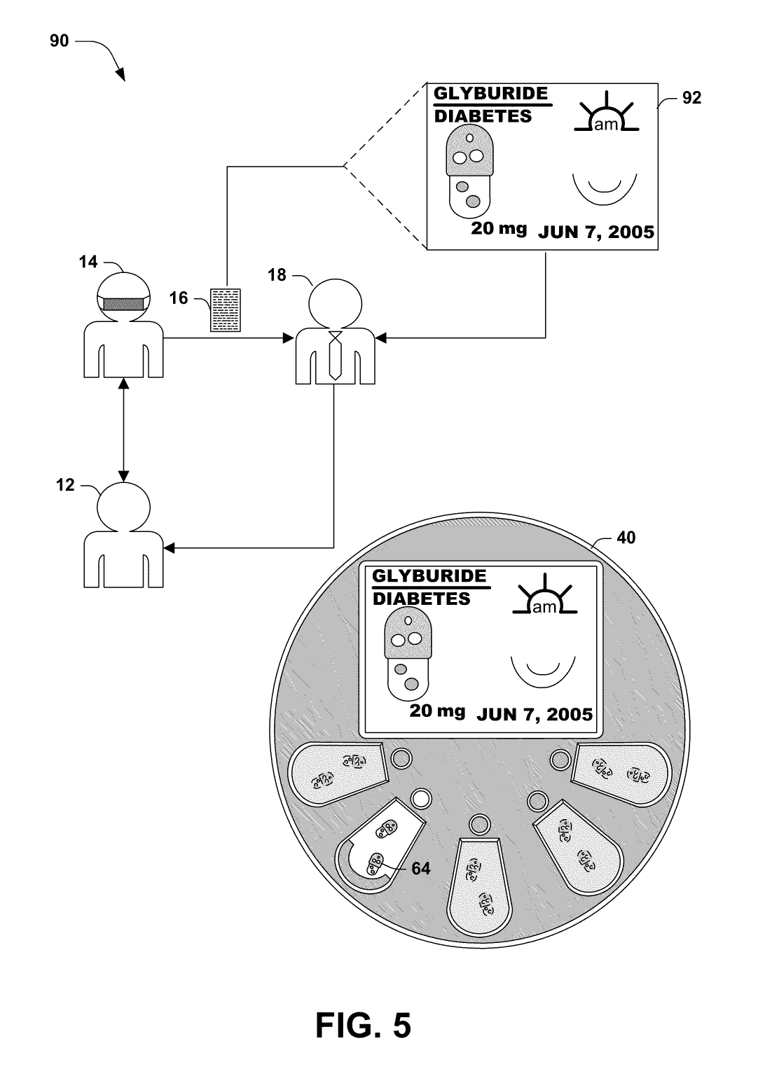

FIG. 5 presents an illustration of an exemplary scenario 90 featuring a provision of medication 64 to an individual 12 as part of a medication regimen in accordance with the techniques presented herein. In this exemplary scenario 90, a caregiver 14 formulates a medication regimen for an individual 12, and conveys the medication regimen as a prescription 16 to a medication source 18. However, instead of providing to the individual 12 the medication 64 and instructions for self-management of the medication regimen, the medication source 18 may utilize a medication reminder device 40. For example, upon receiving the prescription 16, the medication source 18 may obtain a medication reminder device 40, may store one or more medication instructions 56 representing the medication regimen into the medication reminder device 40, and may insert medication 64 corresponding to respective medication instructions 56 in one or more medication chambers 82 of the medication reminder device 40. The medication source 18 may then provide the medication reminder device 40 to the individual 12.

The exemplary scenario 90 of FIG. 5 may present one or more advantages with respect to the exemplary scenarios illustrated in FIG. 1. As a first example, the provision of medication 64 to the individual 12 in a medication reminder device 40 may alleviate problems arising from miscommunication or misunderstanding of the instructions provided by a caregiver 14 and/or medication source 18 regarding the self-administration of the medication 64. That is, rather than relying on the cognitive capabilities and memory of the individual 12 while receiving the instructions from the caregiver 14 and/or medication source 18, compliance with the medication regimen may be predicated upon the logic and automation of the medication reminder device 40. As a second example, the medication reminder device 40 may detect and warn of errors that may otherwise be performed by the caregiver 14 (e.g., prescribing an incorrect medication 64), medication source 18 (e.g., attempting to load the wrong medication 64 into a medication chamber 82) and/or the individual 12 (e.g., attempting to take a dose of a medication 64 that is not authorized by the medication regimen). As a third example, even the communication among the caregiver 14 and the medication source 18, and accompanying opportunities for error, may be reduced. As a first example, the medication instructions 56 generated by the caregiver 14 may comprise processor-executable instructions that may be loaded directly into the medication reminder device 40, such as an extensible markup language (XML) document formatted according to a standardized schema for specifying medication instructions 56, thereby reducing errors in translation and/or transmission of the instructions among the caregiver 14, the medication source 18, and the individual 12. As a second such example, in some embodiments, the same medication icons 62 used to present the medication instruction 56 to the individual 12 may also facilitate entry of the medication instructions 56 by the caregiver 14 and/or an understanding of the medication regimen while loading a medication reminder device 40 by the medication source 18. For example, the medication reminder device 40 may communicate with the caregiver 14 and/or the medication source 18 utilizing a standardized set of icons depicting various aspects of respective medication instructions 56 of the medication regimen (e.g., as per the exemplary presentation 92 of icons 62 comprising the medication instruction 56). Such icons may present a familiar lexicon for communicating aspects of medication instructions 56, and may remove some of the opportunities for miscommunication or misunderstanding that may arise with prescriptions 16 authored using natural-language instructions, particularly in view of language differences among the caregiver 14, the medication provider 18, and the individual 12. Those of ordinary skill in the art may devise many ways whereby the provision of medication 64 to an individual 12 in a medication reminder device 40 may improve upon traditional techniques of providing medication 64 to the individual 12.

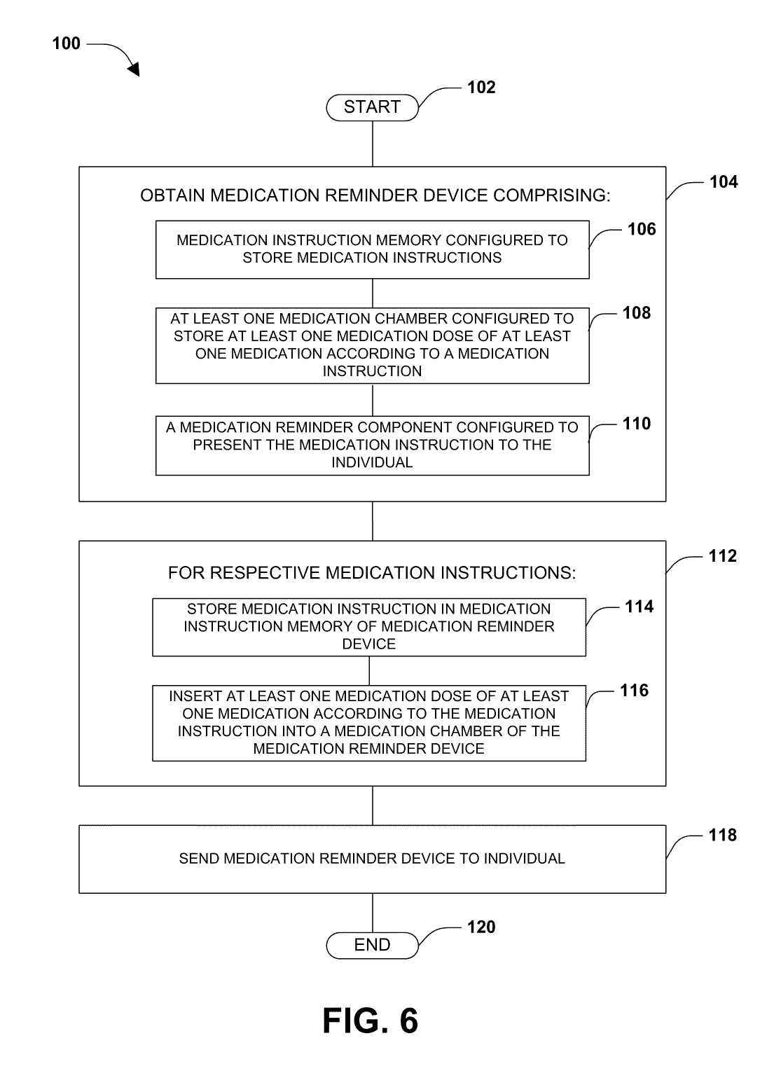

FIG. 6 presents a first embodiment of these techniques, illustrated as an exemplary method 100 of dispensing a medication 64 specified by at least one medication instruction 56 of a medication regimen formulated by a caregiver 14 for an individual 12. At least some portions of the exemplary method 100 may be implemented, e.g., as instructions stored in a memory component of a device (e.g., a memory circuit, a platter of a hard disk drive, a solid-state storage device, or a magnetic or optical disc) that, when executed on a processor of the device, cause the device to perform at least some portions of the exemplary method 100. The exemplary method 100 begins at 102 and involves obtaining 104 a medication reminder device 106 comprising a medication instruction memory 44 configured to store medication instructions 56; at least one medication chamber 108 configured to store at least one medication dose of at least one medication 64 according to at least one medication instruction 56; and a medication reminder component 110 configured to present the medication instruction 56 to the individual 12. The exemplary method 100 also involves, for respective 112 medication instructions 56, storing 114 the medication instruction 56 in the medication instruction memory 106 of the medication reminder device 40; and inserting 116 at least one medication dose of at least one medication 64 according to the medication instruction 56 into a medication chamber 108 of the medication reminder device 40. The exemplary method 100 also involves sending 118 the medication reminder device 40 to the individual 12. Having achieved the dispensation of the medication 64 to the individual 12 with the medication 64 and medication instructions 56 pre-loaded into a medication reminder device 40, the exemplary method 100 ends at 120.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

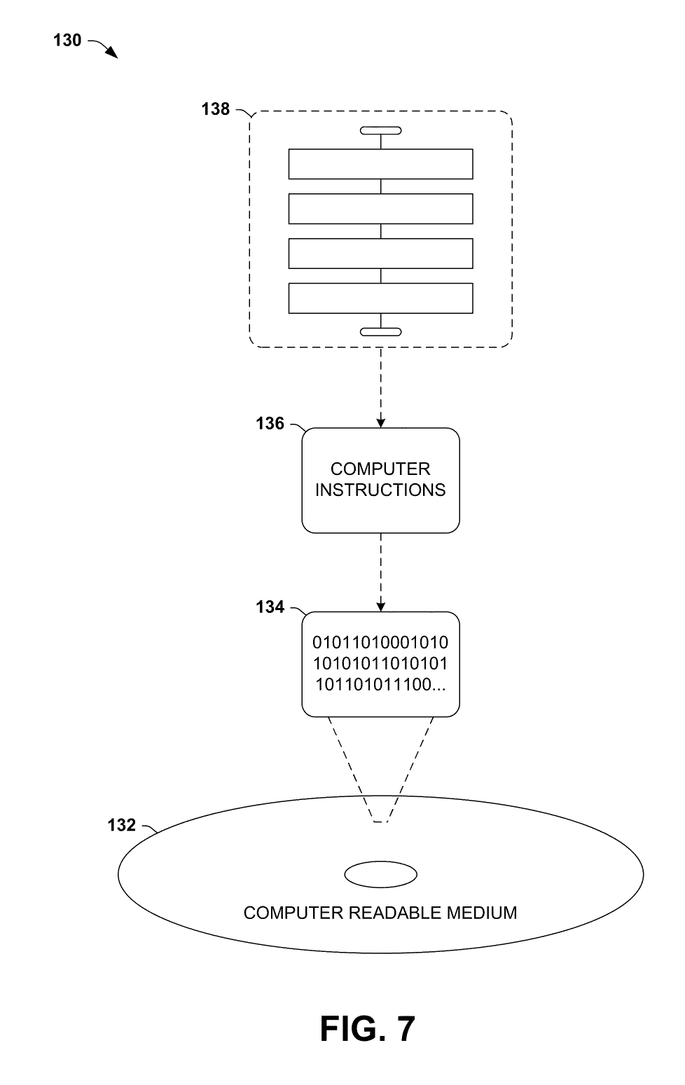

An exemplary computer-readable medium that may be devised in these ways is illustrated in FIG. 7, wherein the implementation 130 comprises a computer-readable medium 132 (e.g., a CD-R, DVD-R, or a platter of a hard disk drive), on which is encoded computer-readable data 134. This computer-readable data 134 in turn comprises a set of computer instructions 136 configured to operate according to the principles set forth herein. In one such embodiment, the processor-executable instructions 136 may be configured to perform a method of providing medication according to a medication regimen to an individual, such as the exemplary method 100 of FIG. 6. In another such embodiment, the processor-executable instructions 136 may be configured to implement a system for providing medication 64 according to a medication regimen to an individual 12. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 100 of FIG. 6) to confer individual and/or synergistic advantages upon such embodiments.

A first aspect that may vary among embodiments of these techniques relates to the scenarios wherein such techniques may be utilized. As a first example, the medication regimen prescribed by the caregiver 14 for the individual 12 may comprise many forms, such as a prescription of a regulated medication 64, an over-the-counter medication 64, or a set of vitamins or nutritional supplements prescribed for the individual 12. As a second example, many types of medication sources 18 may supply the medication 64 to the individual 12, such as pharmacists, nutritionists, home health aides, and pharmaceutical manufacturers and outlets. As a third example, the medication regimen may generally address the health of the individual 12; may have been formulated to address or improve an organ, organ system, or physiological capability of the individual 12; or may have been formulated as a preventative, curative, and/or palliative effect on a particular health condition of the individual 12, such as a disease or predisposition thereto. As a fourth example, many types of medication 64 may be involved in the medication regimen and/or inserted into the medication reminder device 40, including pills, capsules, tablets, ointments, liquids, aerosols, or gases. Those of ordinary skill in the art may devise many scenarios wherein the techniques disclosed herein may be utilized.

A second aspect that may vary among embodiments of these techniques relates to the manner of loading 110 medication 64 into a medication reminder device 40. As a first example, the loading may be conducted automatically; e.g., a computer administrated by the medication source 18 may receive the medication regimen from the caregiver 12 and may automatically prepare the medication reminder device 40 to be sent to the individual 12. Alternatively, a human (representing the medication source 18) may perform the loading, which may or may not be assisted by a computer. As a first such variation, a computer may assist the human in loading the medication reminder device 40 by displaying the medication instructions 56, and in particular through the presentation of icons, such as in the exemplary presentation 92 of FIG. 5. As a second such variation, the medication reminder device 40 or a computer may verify the accuracy of the medication 64 inserted into the medication reminder device 40 by the human. For example, the medication reminder device 40 may comprise at least one medication dose sensor that is configured to measure one or more physical dimension (e.g., mass, size, colors, or numbers) of medication 64 in one or more medication chambers 82, and may compare the physical dimension of the medication in the medication chamber with the physical dimension of the medication 64 to be loaded in the medication chamber 82 according to the medication regimen. This variation may enable an automatic double-checking of the dispensing performed by the human to reduce misunderstanding or error by the human in filling the medication reminder device 40.

As a second example of this second aspect, medication 64 may be loaded into medication chambers 82 of the medication reminder device 40 in many ways. In particular, for medication reminder devices 40 comprising at least two medication chambers 82, the medication regimen may comprising two or more medication instructions 56 having a medication instruction relationship that affects the loading of medication 64 into particular medication chambers 82 of the medication reminder device 40.

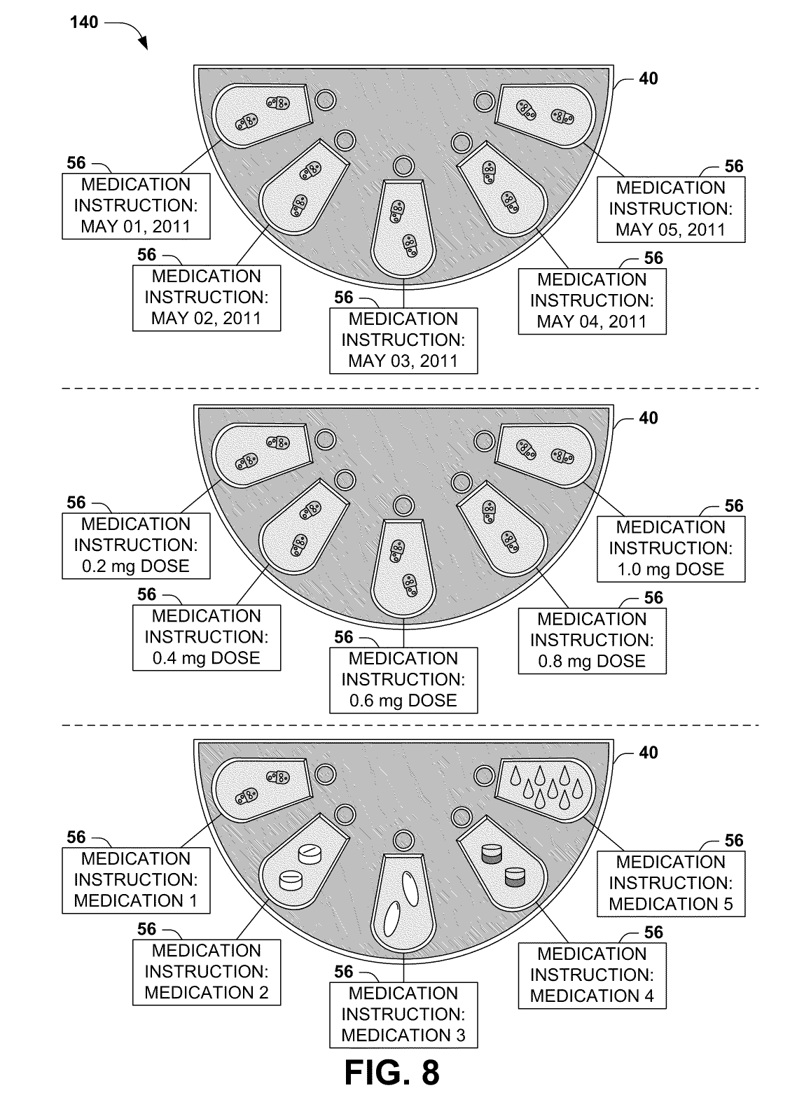

FIG. 8 presents some exemplary scenarios featuring different ways of loading a medication reminder device 40 based on different medication instruction relationships. In a first exemplary scenario 140, the medication instruction relationship comprises a chronology, wherein a first medication instruction 56 arising on a particular date and being used to load a first medication chamber 82, and a second medication instruction 56 arising on the next consecutive date and being used to load the next medication chamber 82 in the sequence. In a second exemplary scenario 142, the medication instruction relationship comprises a dosage, wherein a sequence of dosages of medication 64 specifies how the medication 64 is loaded into the sequence of medication chambers 82 (e.g., permitting the individual 12 to select an appropriate dosage of the medication 64). As a third exemplary scenario 144, respective medication chambers 82 may be loaded with different medications 64. While this exemplary scenario 144 may complicate the provision of medication instructions 64 (e.g., “take one tablet in medication chamber #2 and one lozenge from medication chamber #3”), this exemplary scenario 144 may reduce disadvantages involved in combining different forms of medication 64. Other medication instruction relationships may also lead to particular allocations of medications 64 to medication chambers 82, e.g., a health condition relationship, wherein respective medication chambers 82 hold the types and/or doses of medication 64 pertaining to particular health conditions (e.g., heart condition medication in a first medication chamber 82 and diabetes medication in a second medication chamber 82).

As a third example of this second aspect, the loading 110 of the medication reminder device 40 with medication 64 may also include the loading of annotations to the medication instructions 56. Such annotations may be generated by the caregiver 14 and/or the medication source 18, and may supplement the medication instructions 64 with additionally useful information (e.g., “do not operate heavy machinery within six hours of taking this medication”). The annotations may then be displayed to the individual 12 upon displaying the medication instructions 56. For example, the medication reminder device 40 may include a medication instruction annotation memory that is configured to store one medication instruction annotations associated with medication instructions 64, and a medication instruction annotation presentation component that is configured to present to the individual 12 the medication instruction annotations with one or more associated with respective medication instructions 56. Those of ordinary skill in the art may devise many ways of loading the medication chambers 82 of a medication reminder device 40 in accordance with the techniques presented herein.

A third aspect that may vary among embodiments of these techniques relates to the manner of sending 118 the medication reminder device 40 to the individual 14. As a first example, the medication reminder device 40 may be hand-delivered by the medication provider 18 to the individual 12, or may be delivered via the caregiver 14 (e.g., the medication provider 18 may send the medication reminder device 40 to the caregiver 14 for verification of the contents before delivery to the individual 12). Alternatively, the medication source 18 may deliver the medication reminder device 40 to the individual 12 via a carrier, such as a postal service or a courier service. In some scenarios, several medication delivery paths may be available for delivering the medication reminder device 40 to the individual 12, and the medication source 18 may select a suitable medication delivery path among the available options. For example, two postal services may be available, one of which may be more expensive but faster than the other, and the medication source 18 may select one of the postal services based on the urgency of the medication 64 for the individual 12. Additionally, the selection of a medication delivery path may be made in view of one or more medication condition sensitivities; e.g., a medication may have a particularly short-lived viability or a particular delivery date to the individual 12, or may have to be kept cool during delivery through the use of dry ice or liquid nitrogen. In these scenarios, the medication reminder device 40 may be deliverable to the individual 12 through two or more medication delivery paths respectively having at least one delivery condition (e.g., a particularly fast or precise delivery window, or the capability of delivering a dry-ice package), and among the medication delivery paths, the medication source 18 may select a medication delivery path according to the medication sensitivity conditions of the medication 64 in the medication reminder device 40.

As a second example of this third aspect, the medication 64 may be delivered to a particular medication outlet specified by the individual 12. For example, the caregiver 14 and/or medication source 18 may be able to deliver the medication 64 to many locations that the individual 12 may visit to receive the medication 64 (e.g., one or more pharmacy locations, or postal delivery to one of several addresses specified by the individual 12). The medication source 18 may use this information to send the medication reminder device 40 to a medication outlet based on the instructions of the individual 12. Additionally, after sending the medication reminder device 40 to a particular medication outlet, the medication source 18 may receive a notification that the medication outlet has received the medication reminder device 40, and may notify the individual 12 that the medication reminder device 40 is available for pickup. Alternatively or additionally, the medication source 18 may be notified by the medication outlet when the individual 12 receives the medication reminder device 40, and may, upon failing to receive such a notification within a notification period (e.g., a particular amount of time when the medication 64 is to be received by the individual 12), notify the caregiver 14 that the individual 12 has not received the medication 64.

As a third example of this third aspect, the medication source 18 may include additional resources with the medication reminder device 40. As a first such variation, the medication source 18 may include a prepaid mailer that the individual 12 may use to return the medication reminder device 40 to the medication source 18 (e.g., in order to promote re-use of medication reminder devices 40, or to facilitate a refill). As a second such variation, one or more doses of medication 64 may be administered through the use of a medication dispenser (e.g., a nebulizer, liquid dropper, syringe, or needle), and the medication source 18 may include one or more medication dispensers with the medication reminder device 40. Those of ordinary skill in the art may devise many variations in the delivery of the medication reminder device 40 to the individual 12 in accordance with the techniques presented herein.

A fourth aspect that may vary among embodiments of these techniques relates to the maintenance of the medication regimen of the individual 12 by the medication source 18 and/or caregiver 14 after providing the medication reminder device 40. As a first example, if the medication source 18 is notified of an update to the medication regimen of the individual 12 (e.g., an adjusted dosage or the addition, change, or removal of a type of medication 64), the medication source 18 may send a new medication reminder device 40 to the individual 12. For example, the medication source 18 may compare the original medication regimen with the updated medication regimen to determine at least one updated medication instruction 56 affecting at least one medication dose of at least one medication 64 provided in a first medication reminder device 40, and may then send to the individual 12 a second medication reminder device 40 storing the updated medication instruction and at least one medication dose of the medications 64 associated with the updated medication instruction 56.

As a second example of this fourth aspect, the medication source 18 may generate and send refills of the medications 64 included in the medication reminder device 40. For example, upon detecting a depletion of a medication 64 in the medication reminder device 40 that is subject to a refill according to the medication regimen, the medication source 18 may insert medication dose refills of the medication 64 into one or more medication chambers 82 of a medication reminder device 40, and may send the medication reminder device 40 to the individual 12. The depletion may be detected in many ways. As a first such variation, the individual 12 may contact the medication source 18 with a notification of the depletion and a request for a refill of a medication 64 that, according to the medication regimen, is subject to a refill request. As a second such variation, the individual 12 may simply return the depleted medication reminder device 40 to the medication source 18 (e.g., in a prepaid mailer sent by the medication source 18 along with the medication reminder device 40; via a postage mechanism embedded in the medication reminder device 40, e.g., a prepaid postage barcode affixed to the medication reminder device 40 that allows the individual 12 to return the medication reminder device 40 simply by dropping it in a mailbox). The medication source 18 may simply refill the returned medication reminder device 40 and send it back to the individual 12. As a third such variation, the medication source 18 may receive a notification of a depletion directly from the medication reminder device 40 (e.g., via a sensor embedded in a medication chamber 82 that detects a depletion of the medication 64 contained therein). As a fourth such variation, the medication source 18 may simply estimate the depletion of the medication 64 according to the medication regimen (e.g., issuing a refill two weeks after initially dispending fourteen doses of a medication 64 to be taken daily).

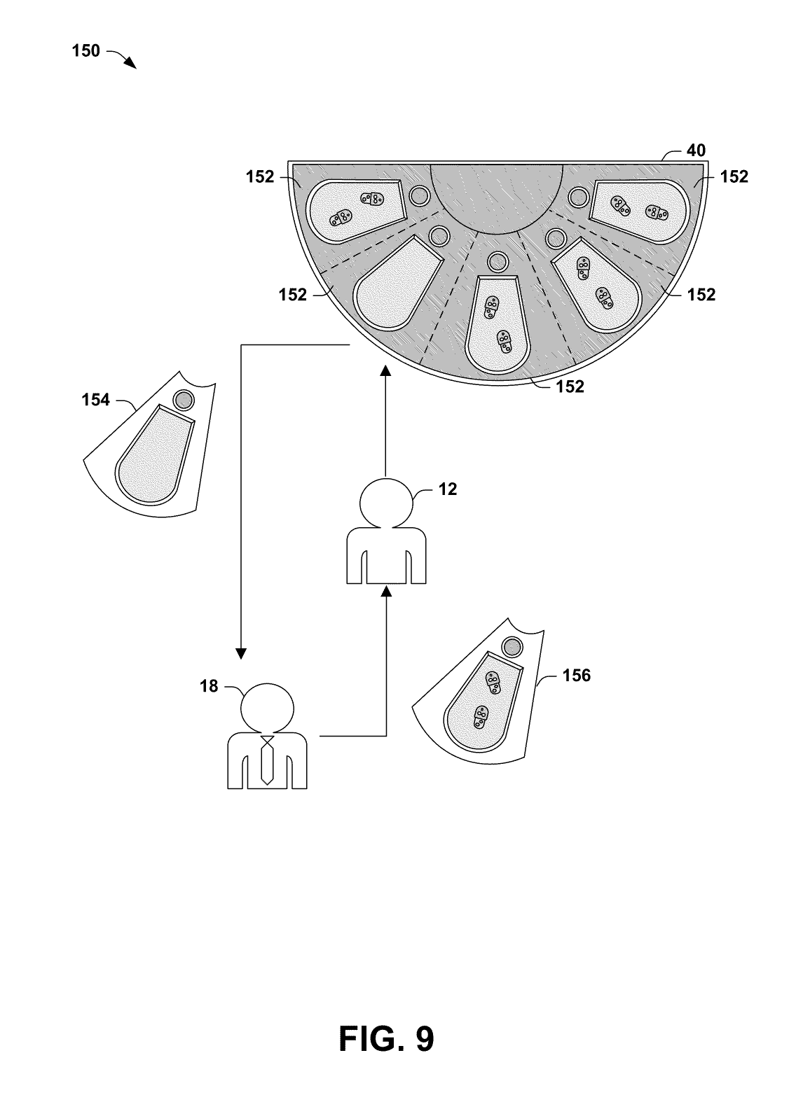

FIG. 9 presents an illustration of an exemplary scenario 150 featuring a particular manner of refilling the medication reminder device 40, comprising one or more modular medication chambers 152 that may be detached from the medication reminder device 40. For example, when a modular medication chamber 152 is depleted, the medication source 18 may prepare a medication dose refill by inserting medication 64 into a replacement modular medication chamber 156 and sending the replacement modular medication chamber 156 to the individual 12. The individual 12 may simply unplug the depleted modular medication chamber 154 from the medication reminder device 40 and insert the replacement modular medication chamber 156 into the medication reminder device 40 to complete the refilling of the medication 64. The medication reminder device 40 may similarly contain logic that identifies the detachment of the depleted modular medication chamber 154, the insertion of a replacement modular medication chamber 156, and/or updates to medication instructions 64 (e.g., expressed via instructions embedded with the replacement modular medication chamber 156), and may update the medication regimen and/or medication instruction memory 44 accordingly. Those of ordinary skill in the art may devise many ways of maintaining the medication regimen through the medication reminder device 40 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

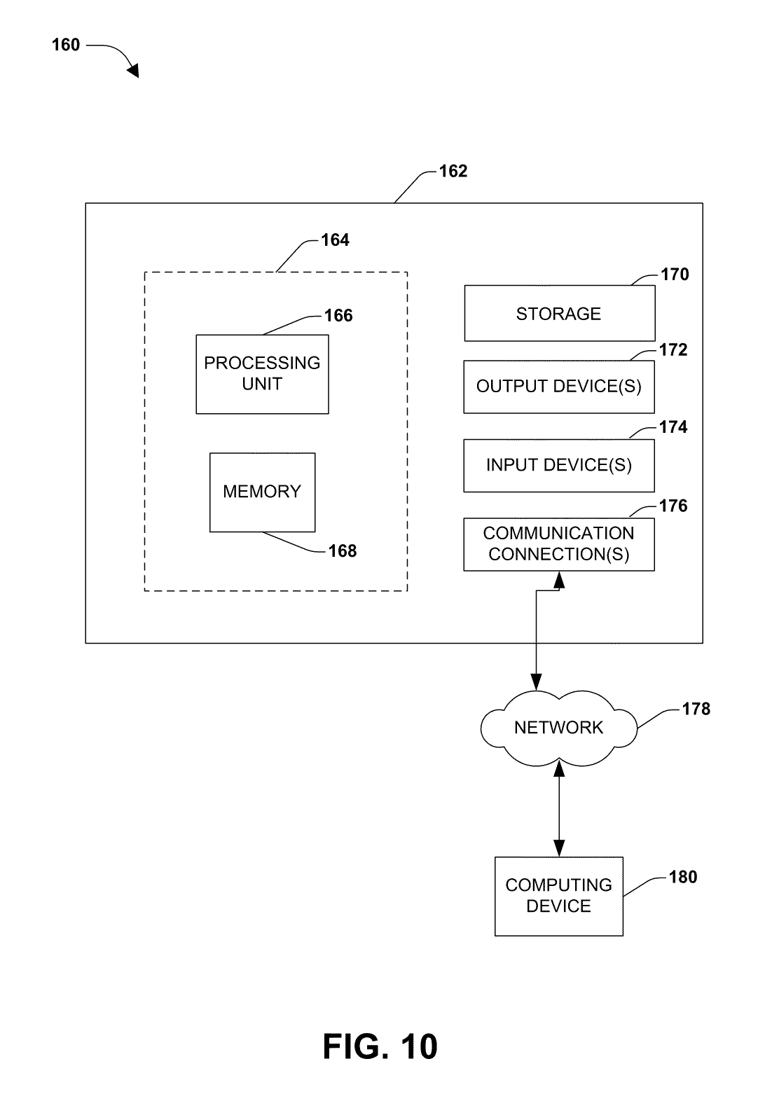

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 10 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 10 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of dispensing a medication specified by at least one medication instruction of a medication regimen formulated by a caregiver for an individual, the method comprising:
obtaining a medication reminder device comprising:
a medication instruction memory configured to store medication instructions;
at least one medication chamber configured to store at least one medication dose of at least one medication according to at least one medication instruction; and
a medication reminder component configured to present the medication instruction to the individual;
for respective medication instructions:
storing the medication instruction in the medication instruction memory of the medication reminder device, and
inserting at least one medication dose of at least one medication according to the medication instruction into a medication chamber of the medication reminder device; and
sending the medication reminder device to the individual.

2. The method of claim 1:
the method performed using a computer having a processor;
storing the medication instruction comprising: executing instructions on the processor configured to store the medication instruction in the medication instruction memory of the medication reminder device; and
inserting the at least one medication dose comprising: executing instructions on the processor configured to insert the at least one medication dose of the at least one medication according to the medication instruction into a medication chamber of the medication reminder device.

3. The method of claim 2:
the at least one medication dose of at least one medication inserted into the medication reminder device by a second individual;
the method performed using a computer having a processor and a display; and
the method comprising: executing on the computer instructions configured to present respective medication instructions to the second individual by displaying on the display a set of icons that together depict:
the at least one medication dose of the at least one medication, and
the medication chamber into which the at least one medication dose of the at least one medication is to be inserted.

4. The method of claim 1:
the medication reminder device comprising at least one medication dose sensor configured to measure at least one physical dimension of the medication in the medication chamber; and
inserting the at least one medication dose of the at least one medication into a medication chamber of the medication reminder device comprising: comparing the at least one physical dimension of the medication in the medication chamber with the physical dimension of at least one medication dose of at least one medication to be loaded in the medication chamber according to at least one medication instruction.

5. The method of claim 1:
the medication reminder device comprising at least two medication chambers;
the medication regimen comprising at least two medication instructions having a medication instruction relationship; and
inserting the at least one medication dose of the at least one medication into the medication chambers of the medication reminder device comprising: inserting the medication doses of the medication into medication chambers according to the medication instruction relationships of the medication instructions.

6. The method of claim 1, the medication instruction relationship selected from a medication instruction relationship set comprising:
a medication instruction chronology relationship;
a medication dosage relationship;
a medication type relationship; and
a health condition relationship of respective medication instructions with at least one health condition of the individual.

7. The method of claim 1:
the medication reminder device comprising:
a medication instruction annotation memory configured to store at least one medication instruction annotation associated with at least one medication instruction, and
a medication instruction annotation presentation component configured to, upon presenting a medication instruction to the individual, presenting the at least one medication instruction annotation associated with the medication instruction to the individual; and
the method comprising: for at least one medication instruction, storing at least one medication annotation associated with the medication instruction in the medication instruction annotation memory.

8. The method of claim 1:
at least one medication dose of at least one medication in the medication reminder device administered to the individual using a medication dispenser; and
sending the medication reminder device to the individual comprising: sending at least one medication dispenser of the at least one medication to the individual with the medication reminder device.

9. The method of claim 1:
at least one medication in the medication reminder device having a medication condition sensitivity;
the medication reminder device deliverable to the individual through at least two medication delivery paths respectively having at least one delivery condition; and
the method comprising: among the medication delivery paths, selecting a medication delivery path for the medication reminder device according to the medication sensitivity conditions of the medication in the medication reminder device.

10. The method of claim 1, sending the medication reminder device to the individual comprising: sending the medication reminder device to a medication outlet specified by the individual.

11. The method of claim 10, sending the medication reminder device to the individual comprising: upon receiving a receipt notification of the medication reminder device from the medication outlet, notifying the individual of an availability of the medication reminder device at the medication outlet.

12. The method of claim 10, sending the medication reminder device to the individual comprising: upon failing to receive, within a notification period, a notification from the medication outlet of a receipt of the medication reminder device by the individual, notifying the caregiver.

13. The method of claim 1, comprising: upon receiving from the caregiver an updated medication regimen:
comparing the medication regimen with the updated medication regimen to determine at least one updated medication instruction affecting at least one medication dose of at least one medication;
obtaining a second medication reminder device;
for respective updated medication instructions:
storing the updated medication instruction in the medication instruction memory of the second medication reminder device, and
inserting at least one medication dose of at least one medication according to the updated medication instruction into a medication chamber of the second medication reminder device; and
sending the second medication reminder device to the individual.

14. The method of claim 1, comprising: upon detecting a depletion of a medication subject to a refill according to the medication regimen:
inserting at least one medication dose refill of the medication into at least one medication chamber of a medication reminder device, and
sending the medication reminder device to the individual.

15. The method of claim 14:
detecting the depletion comprising: receiving from the individual the medication reminder device having a depletion within at least one medication chamber of the medication doses of at least one medication subject to a refill according to the medication regimen; and
inserting the medication dose refill comprising: inserting at least one medication dose refill of at least one medication according to the medication instruction into a medication chamber of the medication reminder device.

16. The method of claim 14, inserting the medication dose refill comprising:
obtaining a second medication reminder device;
storing the medication instruction in the medication instruction memory of the second medication reminder device; and
inserting at least one medication dose refill of at least one medication according to the medication instruction into a medication chamber of the second medication reminder device.

17. The method of claim 16, detecting the depletion of the medication chamber comprising: receiving a refill request from the medication reminder device.

18. The method of claim 16, detecting the depletion of the medication chamber comprising: estimating a depletion of the medication chamber according to the medication regimen.

19. The method of claim 14:
at least one medication chamber of the medication reminder device comprising a modular medication chamber configured to detach from the medication reminder device;
inserting the at least one medication dose refill comprising: inserting at least one medication dose refill of the medication subject to a refill according to the medication regimen into at least one modular medication chamber; and
sending the medication reminder device comprising: sending the at least one modular medication chamber to the individual.

20. A method of dispensing a medication specified by at least one medication instruction of a medication regimen formulated by a caregiver for an individual, at least one medication dose of at least one medication in the medication reminder device administered to the individual using a medication dispenser, at least two medication instructions having a medication instruction relationship, and the method performed using a computer having a processor and comprising:
obtaining a medication reminder device comprising:
a medication instruction memory configured to store medication instructions;
at least one medication chamber configured to store at least one medication dose of at least one medication according to at least one medication instruction;
a medication reminder component configured to present the medication instruction to the individual;
at least one medication dose sensor configured to measure at least one physical dimension of the medication in the medication chamber;
a medication instruction annotation memory configured to store at least one medication instruction annotation associated with at least one medication instruction; and
a medication instruction annotation presentation component configured to, upon presenting a medication instruction to the individual, presenting the at least one medication instruction annotation associated with the medication instruction to the individual;
executing on the processor instructions configured to, for respective medication instructions:
store the medication instruction in the medication instruction memory of the medication reminder device;
insert at least one medication dose of at least one medication according to the medication instruction into a medication chamber of the medication reminder device according to the medication instruction relationships of the medication instructions;
store at least one medication annotation associated with the medication instruction in the medication instruction annotation memory; and
compare the at least one physical dimension of the medication in the medication chamber with the physical dimension of at least one medication dose of at least one medication to be loaded in the medication chamber according to at least one medication instruction;
sending the medication reminder device to a medication outlet specified by the individual with at least one medication dispenser of the at least one medication to the individual with the medication reminder device; and
executing instructions on the processor configured to:
upon receiving a receipt notification of the medication reminder device from the medication outlet, notify the individual of an availability of the medication reminder device at the medication outlet;
upon failing to receive, within a notification period, a notification from the medication outlet of a receipt of the medication reminder device by the individual, notify the caregiver;
upon receiving from the caregiver an updated medication regimen:
compare the medication regimen with the updated medication regimen to determine at least one updated medication instruction affecting at least one medication dose of at least one medication;
obtain a second medication reminder device;
for respective updated medication instructions:
store the updated medication instruction in the medication instruction memory of the second medication reminder device, and
insert at least one medication dose of at least one medication according to the updated medication instruction into a medication chamber of the second medication reminder device; and
send the second medication reminder device to the individual; and
upon detecting a depletion of a medication subject to a refill according to the medication regimen:
insert at least one medication dose refill of the medication into at least one medication chamber of a medication reminder device, and
send the medication reminder device to the individual.
